(19) United States
(12) Patent Application Publication
(10) Pub. No.: US 2022/0295931 A1
(43) Pub. Date: Sep. 22, 2022

(54) ATTACHMENT FOR CAPS

(71) Applicant: Snaps Ventures Inc., Jupiter, FL (US)

(72) Inventor: Matthew Ryan Eldridge, Jupiter, FL (US)

(73) Assignee: Snaps Ventures Inc., Jupiter, FL (US)

(21) Appl. No.: 17/616,063

(22) PCT Filed: Jun. 3, 2020
(86) PCT No.: PCT/US2020/036006

§ 371 Date: Dec. 2, 2021

Related U.S. Application Data
(60) Provisional application No. 62/933,332, filed on Nov. 8, 2019.
(60) Provisional application No. 62/980,138, filed on Feb. 21, 2020.
(60) Provisional application No. 62/857,267, filed on Jun. 4, 2019.

(51) Int. Cl. A42B 1/248; A42B 1/242; G09F 21/02

(52) U.S. Cl. CPC A42B 1/248; A42B 1/242; G09F 21/02

(57) ABSTRACT

An attachment for mounting on straps extending between a rear opening of a cap. The attachment comprises a first panel having an outer and inner surface, a connector, and a second panel having an outer and inner surface. The panels are spaced such that the first and second panels face each other and are substantially parallel to each other. The connector connects the first panel and the second panel at the top edge of the first panel and defines a gap between the panels. The gap is sufficient to permit the strap or straps to nest within, such that when the strap or straps are nested, the first and second panels lie on opposite sides of the strap or straps. The outer surfaces of the panels display advertising indicia or decoration and have a cushioned area. The attachment may include a clip for holding at least a portion of the strap(s) against the first panel.

### CROSS-REFERENCE TO RELATED APPLICATIONS

This application claims the benefit under 35 U.S.C. 119(e) to U.S. Provisional Application No. 62/980,138, filed Feb. 21, 2020 and entitled “ATTACHMENT FOR CAPS”, U.S. Provisional Application No. 62/933,332, filed Nov. 8, 2019 and entitled “ATTACHMENT FOR CAPS”, and U.S. Provisional Application No. 62/857,267, filed Jun. 4, 2019 and entitled “ATTACHMENT FOR CAPS”. The entirety of each of the applications listed above is incorporated herein by reference.

### FIELD

Embodiments disclosed herein relate generally to attachments for caps, such as baseball caps. The attachments may include a logo, a visual, a design, and/or advertissing.

### DISCUSSION OF THE RELATED ART

Baseball-style caps are known to include an opening at the back with one or more straps extending across the opening. Caps may be adjustable in size, for example, by using adjustable straps or an elastic band. These caps often display various logos on the front of the cap. Attachments that attach to straps of these caps and display various advertising indicia are also known, such as those disclosed in U.S. Pat. Nos. 5,499,402, 5,533,213, 5,003,640, 5,600,855, and D412,937. Given the popularity of people wearing their caps backwards, attachments that display the advertising indicia at the back or rear of the cap are also known, such as those disclosed in U.S. Pat. No. 5,418,981. These products are able to display advertising on the caps but are not comfortable to wear, especially when the cap is worn backwards and the attachment touches the forehead of the person causing irritation. Additionally, these attachments do not sit well on the cap strap or straps when the cap size gets adjusted thereby limiting their use to certain caps.

### SUMMARY

According to one embodiment, a cap attachment includes a first panel having an outer surface arranged to display one of an indicia, advertising, or digital content, a second panel, a connector arranged to connect the first and second panels, the first and second panels and the connector defining a gap, and a clip arranged to hold at least a portion of a strap of a cap against the first panel, the clip disposed in the opening.

According to another embodiment, a cap attachment includes a first panel having an inner surface and an outer surface, a second panel, a connector arranged to connect a top of each of the first and second panels, wherein the first and second panels and the connector define a gap arranged to receive a strap of a cap, and a clip arranged to hold at least a portion of the strap of the cap against the first panel, the clip being disposed in the gap.

According to another embodiment, a method includes placing a cap attachment over a strap of a cap, the cap attachment having a first panel with an inner surface and an outer surface, a second panel, a connector arranged to connect the first and second panels, the first and second panels and the connector defining a gap, and a clip disposed in the gap, moving the clip in a direction away from the first panel, inserting the strap in between the first panel and the clip, and releasing the clip.

According to yet another embodiment, a cap attachment includes a first panel having an inner surface and an outer surface, a second panel, a connector arranged to connect a top of each of the first and second panels, wherein the first and second panels and the connector defining a gap arranged to receive a strap of a cap, and a clip arranged to hold at least a portion of the strap of the cap against an inner surface of at least one of the first and second panels, the clip being disposed in the gap.

It should be appreciated that the foregoing concepts, and additional concepts discussed below, may be arranged in any suitable combination, as the present disclosure is not limited in this respect.

The foregoing and other aspects, embodiments, and features of the present teachings can be more fully understood from the following description in conjunction with the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a front perspective view of a cap attachment according to one embodiment of the present disclosure;

FIG. 2 is a rear perspective view of the cap attachment of FIG. 1;

FIG. 3 is another rear perspective view of the cap attachment of FIG. 1;

FIG. 4 is a rear perspective view of a cap attachment according to another embodiment;

FIG. 5 is a perspective view of a cap with a cap attachment according to some embodiments;

FIG. 6 is a bottom perspective view of the cap and cap attachment of FIG. 5;

FIG. 7 is a perspective view of a user wearing the cap and cap attachment of FIG. 5;

FIG. 8 is a front view of a cap attachment according to another embodiment;

FIG. 9 is a rear view of the cap attachment of FIG. 8;

FIG. 10 is a top view of the cap attachment of FIG. 8;

FIG. 11 is a bottom view of the cap attachment of FIG. 8;

FIG. 12 is a front view of a cap attachment according to another embodiment;

FIG. 13 is a front perspective view of a cap attachment according to another embodiment;

FIG. 14 is a rear perspective view of the cap attachment of FIG. 13;

FIG. 15 is a perspective view of a cap attachment according to another embodiment;

FIG. 16 is a perspective view of a cap attachment according to still another embodiment;

FIG. 17 is a front perspective view of a cap attachment according to another embodiment;

FIG. 18 is a rear perspective view of the cap attachment of FIG. 17;

FIG. 19 is a front perspective view of a cap attachment according to another embodiment;

FIG. 20 is a rear perspective view of the cap attachment of FIG. 19;

FIG. 21 is a front perspective view of a cap attachment according to another embodiment;

FIG. 22 is a rear perspective view of the cap attachment of FIG. 21;

FIG. 23 is a rear perspective view of a cap attachment according to another embodiment;

FIG. 24A is a cross-sectional side view of the cap attachment of FIG. 23;

FIG. 24B is a cross-sectional side view of a cap attachment according to another embodiment;

FIG. 25 is a rear perspective view of a cap attachment according to another embodiment, shown with a second panel of the cap attachment removed;

FIG. 26 is a rear perspective view of a cap attachment according to another embodiment, shown with a second panel of the cap attachment removed;

FIG. 27 is a rear perspective view of a cap attachment according to another embodiment, shown with a second panel of the cap attachment removed;

FIG. 28 is a rear perspective view of a cap attachment according to another embodiment;

FIG. 29 is a rear perspective view of a cap attachment according to another embodiment;

FIG. 30 is a rear perspective view of a cap attachment according to another embodiment; and

FIG. 31 is a perspective view of a dog collar with a cap attachment according to some embodiments.

### DETAILED DESCRIPTION

Baseball-style caps often have an opening in the rear of the cap. One or more straps typically extend horizontally across the opening and allow for adjustment of the cap size to fit heads of different users. For example, the strap may include an elastic band. Alternatively, the adjustability may be achieved by employing one or two straps with a connection method. For example, a pair of straps having holes and studs, VELCRO® brand hook and loop fasteners, or other connection arrangements, may be used to adjust the size of a cap. The cap may have a fixed strap or a combination of fixed straps and moveable or elastic straps. A strap may include a band, a belt, or other member that extends horizontally across the opening in the rear of a cap.

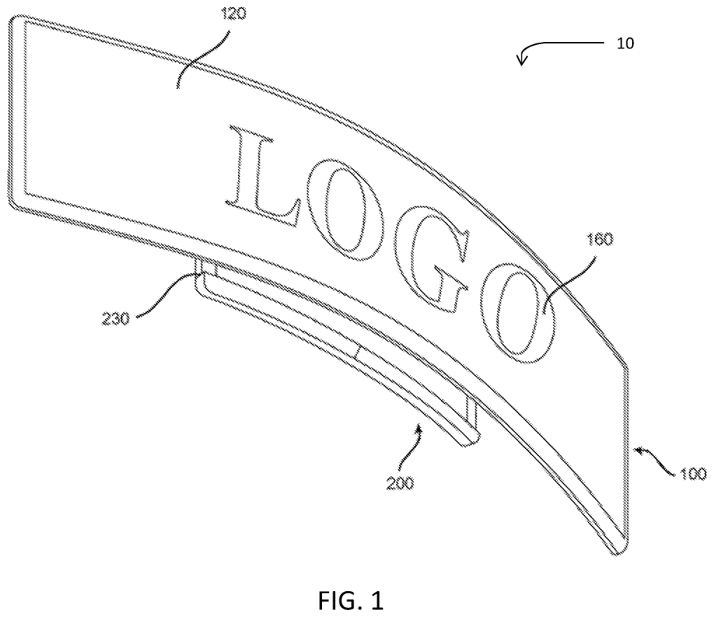

FIGS. 1-3 show an exemplary cap attachment 10 in accordance with one embodiment of the present disclosure. As shown in these views, the cap attachment 10 may include a first panel 100, a second panel 200 and a connector 300. In some embodiments, the second panel 200 and the connector 300 may include a clip section. For example, the second panel and connector may be used to hold the cap attachment on the cap.

In some embodiments, as shown in FIGS. 1-3, the first panel 100 may include an inner surface 110 and an outer surface 120. In such embodiments, the outer surface 120 may be outwardly facing from a center of the cap attachment 10 and the inner surface 110 is inwardly facing toward the center of the cap attachment 10. In some embodiments, the inner surface 110 may face the second panel 200 of the cap attachment 10. In some embodiments, the inner surface 110 of the first panel 110 may be closer to the user's head and be in contact with the cap strap(s).

In some embodiments, as shown in FIG. 1, the outer surface 120 of the first panel may include advertising indicia or decoration 160. For example, the advertising indicia 160 may be, for example, a logo, an image, text, and/or combinations thereof. Alternatively, or in addition to, the outer surface 120 may bear a decoration 160 such as art designs, diamonds, and/or jewels. In some embodiments, the cap attachment 10 may serve an advertising or promotional purpose and/or as a fashion accessory of the cap.

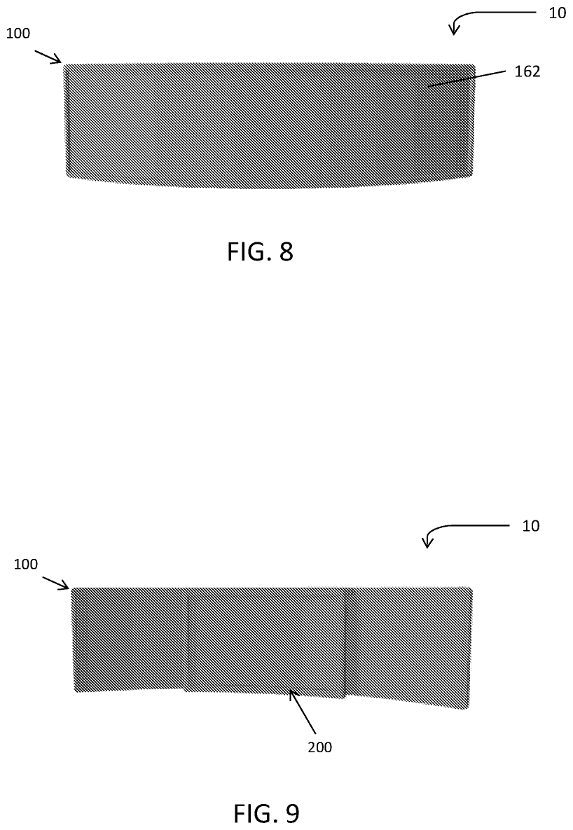

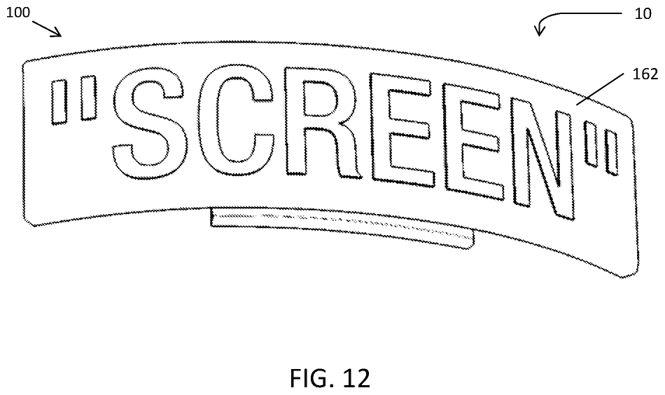

In some embodiments, as shown in FIG. 8-12, the outer surface 120 may include a digital screen 162 that may be used to display advertising indicia, decoration, or other media. For example, the outer surface may include an LCD screen. In some embodiments, the user may display static or dynamic media on the screen. For example, the user may display digital logos, text, videos, or other media on the screen (see, e.g., FIG. 12). As will be appreciated, although only the outer surface of the first panel 100 is shown as having the digital screen (see, e.g., FIG. 8), in some embodiments, the entire first panel 100 may include the digital screen. In some embodiments, the edge of the first panel may include a charging port. In some embodiments, the charging port may be waterproof.

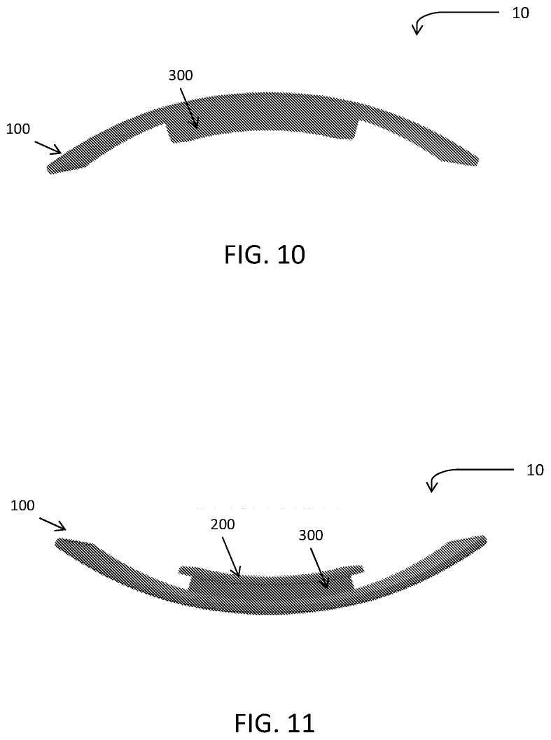

In some embodiments, as shown in FIG. 9, the second panel may be shorter than the first panel. In some embodiments, the second panel may have an outer surface arranged to contact the user, such as the user's hair and/or forehead. In such embodiments, the inner surface of the second panel may face the inner surface of the first panel. In some embodiments, one or both of the inner surfaces may contact one or more straps of the cap. In some embodiments, as shown in FIG. 10, the connector 300 may connect the first and second panels to one another and form a gap between the first and second panels for inserting a strap or band of the cap. In some embodiments, the cap attachment may simply be placed over one or more straps on the cap, although the cap attachment also may snap onto one or more straps of the cap.

In some embodiments, the cap attachment 10 may be connectable to a user's mobile device, such as to a user's smart phone. As will be appreciated, the user may connect to the cap attachment via other suitable devices, such as a laptop computer. In some embodiments, the cap attachment may be connected via wireless, Bluetooth, or other suitable connection. The cap attachment also may be connected via other suitable connection, such as via a wired connection.

In some embodiments, the digital screen may be connected to, e.g., synced with, the user's mobile device. For example, the user may send digital media or content from the user's mobile device to the digital screen on the cap attachment. For example, the user may use an application on the user's smart phone to transfer digital media to the cap attachment. In some embodiments, the user may be able to select the time that a certain image or video is displayed on the digital screen of the cap attachment. For example, the user may select multiple images that may display in a slideshow fashion and in a continuous loop on the screen. In some embodiments, the cap attachment also may include one or more speakers for projecting sound. For example, the one or more speakers may project the sound from a video that is playing on the digital screen on the cap attachment.

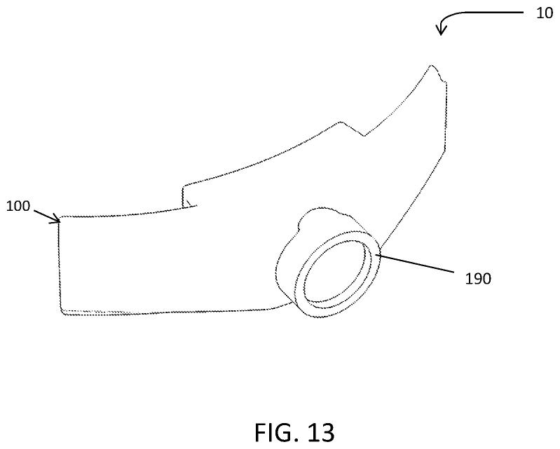

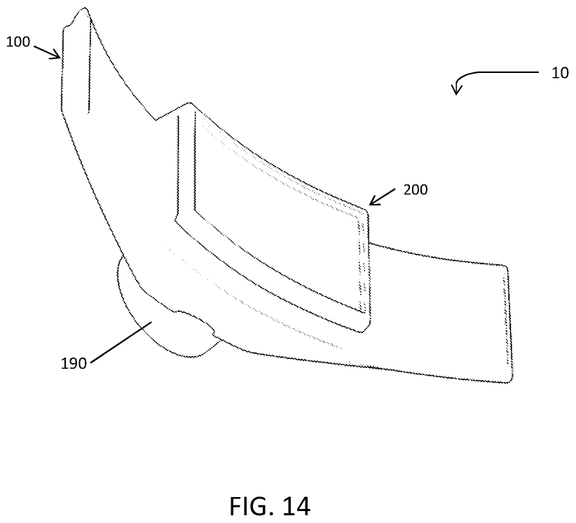

Although the cap attachment is shown and described for displaying advertising indicia, decoration, or other media content, in some embodiments, as shown in FIGS. 13 and 14, the cap attachment may be arranged to capture or record content. For example, as shown in FIGS. 13 and 14, the cap attachment may include a camera 190 arranged to capture images and/or videos. In some embodiments, the camera may be attachable to the first panel 100 of the cap attachment 10. In some embodiments, the camera may be removably attachable to the first panel. The camera also may be fixedly attached to the first panel. For example, the camera may be embedded in the first panel of the cap attachment. For example, the camera may be built-in to the cap attachment. As will be appreciated, although the camera is shown as being attached to first panel, the camera may be attached to other suitable portions of the cap attachment (e.g., to the connector). In some embodiments, the first panel (e.g., a front or forward-facing panel) may include decorations, or other indicia, in addition to the camera.

As with the digital screen, the user may be able to connect to the cap attachment and to the camera, such as to obtain the images or videos captured via the camera. For example, the user may connect to the cap attachment (e.g. via a wireless or Bluetooth connection) such that the images may be retrieved by the user. As with the digital screen, the camera may be synced with the user's mobile device. In other embodiments, the content may be automatically sent to the user. For example, the images and/or videos may be sent via e-mail to the user or may otherwise be uploaded to the user's virtual storage site (e.g., to the user's cloud storage). In other embodiments, the cap attachment may include removable storage (e.g., a memory card) to which the images are saved. In such embodiments, the user may remove the storage from the cap attachment to retrieve the images or videos captured via the camera. In some embodiments, the first panel may include a charging port, such as a wireless charging port.

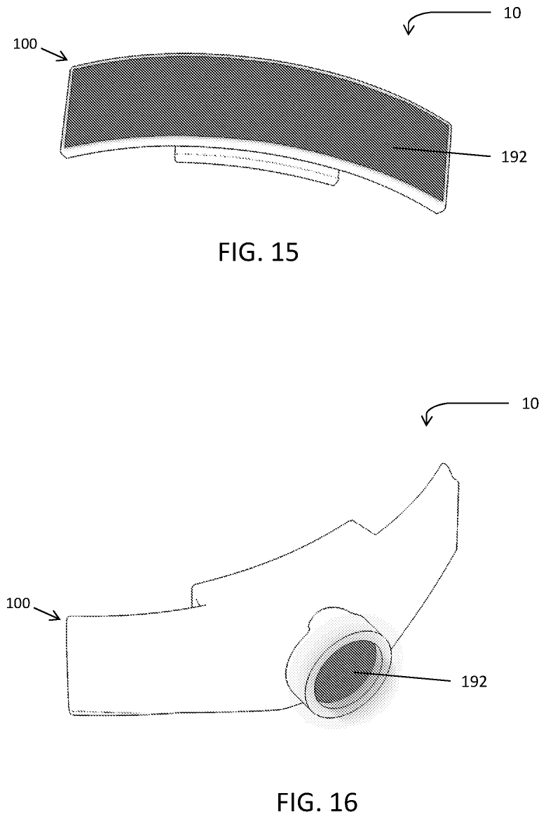

In some embodiments, as shown in FIGS. 15-16, the first panel may include a light 192. In some embodiments, the outer surface may include a red LED safety light, although the light may display other colors. In some embodiments, the light may be flashing. The light also be arranged to illuminate constantly. As will be appreciated, the light also may be programmable to display another desired illumination scheme. In some embodiments, the light may be powered by a battery. As will be appreciated, the battery may be replaceable or it may be rechargeable. In embodiments in which the battery is rechargeable, the first panel may include a charging port, such as a waterproof charging port.

In some embodiments, as shown in FIG. 15, the light may extend across the first panel of the cap attachment. For example, the light may extend across an entire length of the first panel of the cap attachment. In other embodiments, as shown in FIG. 16, the light may be attachable to only a portion of the first panel. In some embodiments, similar to the camera, the light may be removably attachable to the first panel. The light also may be fixedly attached to the first panel. For example, the light may be embedded in the first panel of the cap attachment. In one such example, the light may be built-in to the cap attachment.

Although the light is shown and described as being part of the first panel, it will be appreciated that lights may be attachable to other parts of the cap attachment. For example, in place of, or in addition to, the lights on the front panel, lights may be positioned on the connector of the cap attachment.

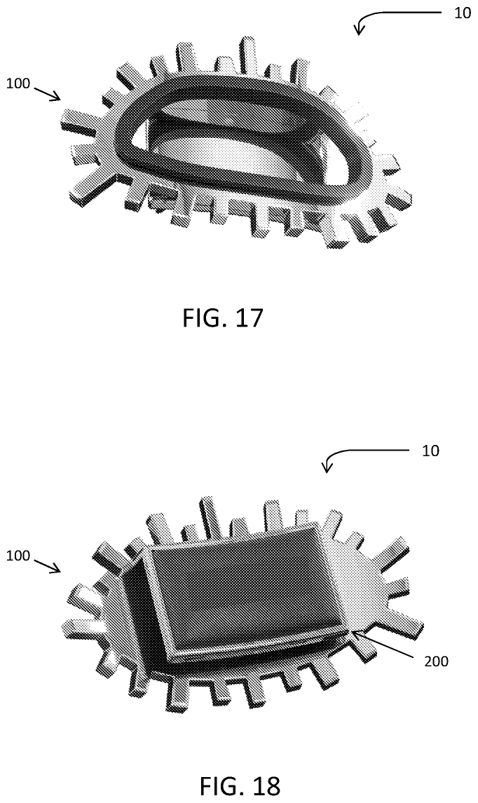

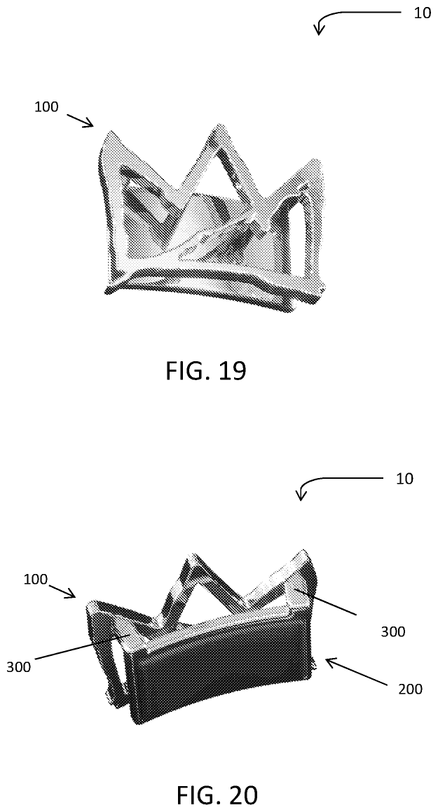

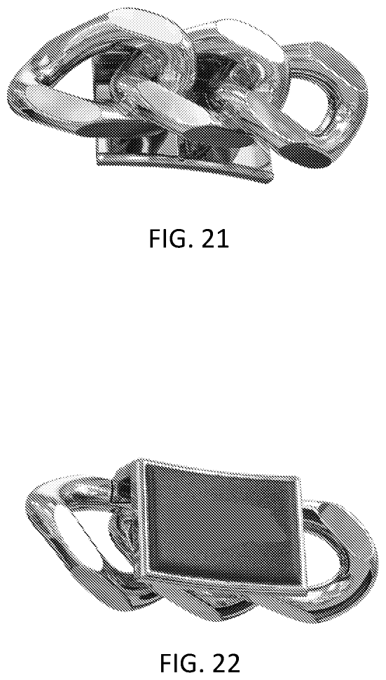

In some embodiments, as shown in FIGS. 17-22, the first panel 100 may be shaped into a three dimensional (“3D”) design. For example, the first panel may have a selected border shape (see, e.g., FIGS. 17 and 19). In such an example, the first panel may include a die-cut of a logo. In some embodiments, the first panel may include a logo that at least partially protrudes from the outer surface of the first panel. In some embodiments, at least a portion of the first panel may be cut out (e.g., hollow). In some embodiments, the 3D design (e.g., logo) may be integrally formed with the first panel, although the 3D design also may be attachable to the first panel. In some embodiments, the cap attachment 100 may include one or more 3D designs that are removably attachable to the outer surface of the first panel. In some embodiments, the first panel may be formed of at least a part of a chain (see, e.g., FIGS. 21 and 22).

In some embodiments, such as that shown in FIGS. 19 and 20 where the first panel is partially cutout, the cap attachment may include more than one connectors 300 to attach the first panel to the second panel. In such embodiments, the connectors may be attached to any suitable portion of the first and/or second panels. The connectors may have the same shape and size, although the shape and size may vary from connector to connector.

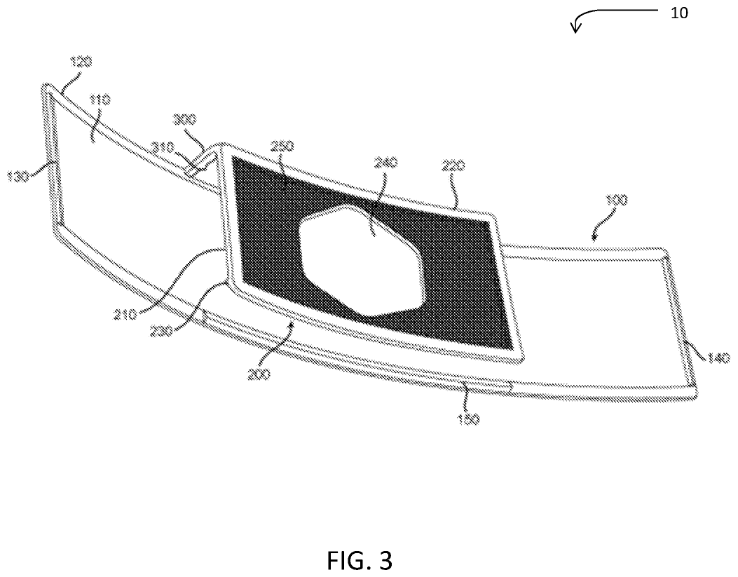

Turning back to FIG. 3, in some embodiments, the first panel 100 may be curved so as to better align with the shape of the user's head. Alternatively, as shown in FIG. 4, the first panel 100 may be flat. In some embodiments, the second panel may be curved. In some embodiments, the second panel may be flat. As will be appreciated, the first and second panels need not both be flat or curved. For example, as shown in FIG. 4, the second panel 200 may be curved so as to better align with the shape of the user's head, while the first panel, bearing the advertising indicia or decoration, may be flat. In some embodiments, the first and second panels may generally be rectangular in shape. Alternatively, the first and/or second panels may be any other suitable shape, such as oval, trapezoid, parallelogram, or another suitable shape. As with the above, the shape and size of the first panel need not be the same as the shape and size of the second panel. For example, the first panel may be rectangular in shape while the second panel may be square.

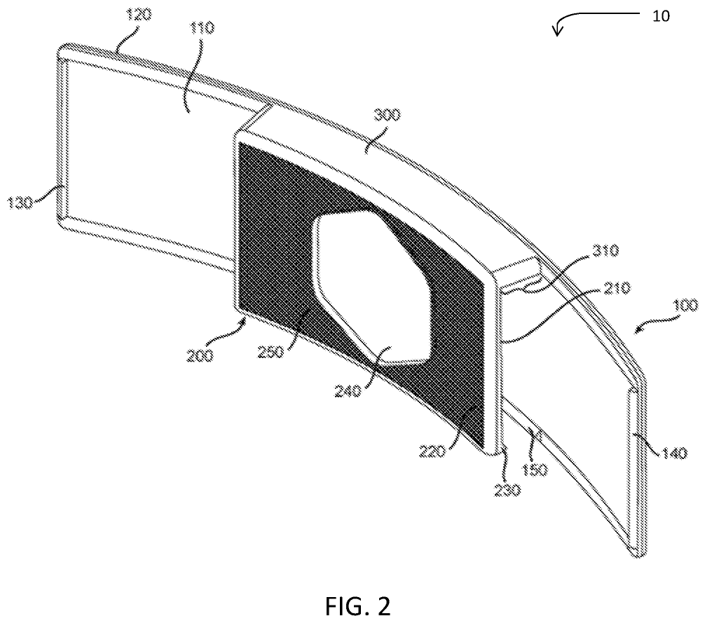

As shown in FIGS. 2-4, the first panel of the cap attachment may be longer than the second panel. In such embodiments, a length of the first panel, or an arc length of the first panel when the first panel is curved, may be longer than a length of the second panel.

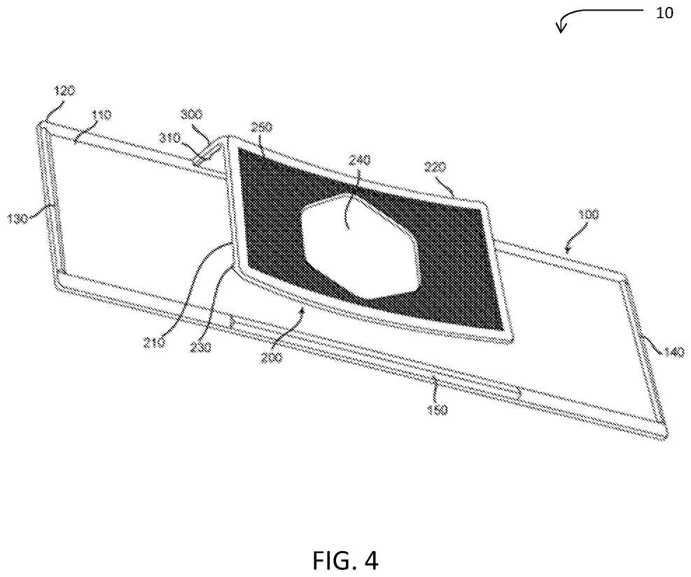

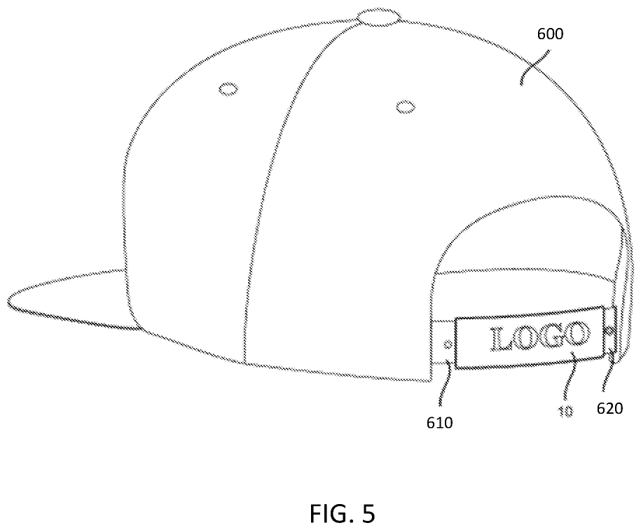

In some embodiments, as shown in FIG. 5, the width of the first panel 100 may be larger than a width of the cap strap(s). In some embodiments, the width may be slightly larger than the width of the cap strap(s). In some embodiments, the first panel 100 may extend at least part way across the opening of the cap. In such embodiments, a length of the first panel may be smaller than a length of the cap strap(s). In some embodiments, the first panel may extend all the way across the opening, or even beyond the opening of the cap. In such embodiments, the length of the first panel may be larger than a length of the cap strap(s).

As shown in FIGS. 3 and 4, the second panel 200 may include an inner surface 210 and an outer surface 220. The inner surface 210 may be inwardly facing toward the center of the cap attachment 10 and in contact with the cap strap(s) when the cap attachment is nested. As will be appreciated, the inner surface 210 of the second panel may face the inner surface 110 of the first panel. In some embodiments, the outer surface 220 is outward facing from the center of the cap attachment 10 and closer to and/or in contact with the user's head.

In some embodiments, the outer surface 220 may have an inset area 240, which, in some embodiments, may display branding and/or advertising indicia. In some embodiments, the inset area 240 may display different branding or advertising indicia than the indicia displayed on the first panel. As will be appreciated, although the cap attachment of FIGS. 3 and 4 are shown with an insert, the cap attachment need not include an inset area 240. In such embodiments, the branding and/or advertising indicia may be displayed only on the first panel.

In some embodiments, as shown in FIGS. 3 and 4, the outside surface 220 of the second panel may contain a soft or cushioned or padded area 250. In embodiments having an inset 240, the soft area 250 may cover the area surrounding the inset 240. The soft area 250 also may cover the entire outside surface 220 of the second panel 200 in embodiments without an inset.

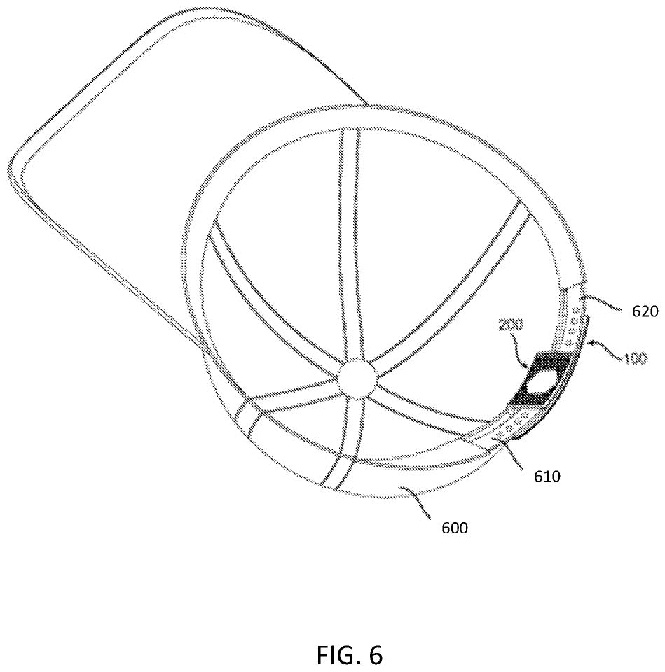

In some embodiments, the width of the second panel 200 may be about the same as the width of the first panel 100. In some embodiments, as shown in FIG. 6, the second panel may be wider than the width of the cap strap(s). In some embodiments, the width of the second panel may be slightly larger than the width of the cap strap(s). In some embodiments, the length of the second panel 200 may be shorter than the length of the first panel 100. For example, in one embodiment, the length of the second panel 200 is approximately half of the length of the first panel 100. In some embodiments, the second panel may extend a least part way across the opening of the cap. In such embodiments, a length of the cap strap(s) may be larger than the length of the second panel.

In some embodiments, the second panel 200 may be centered along the length of the first panel 100. In some embodiments, the second panel 200 may be substantially parallel to the first panel 100 and spaced behind the first panel 100. The inner surfaces 110 and 210 may face each other. In some embodiments, the first and second panels are substantially parallel and slightly curved to conform to a shape of a rear of the user's head.

In some embodiments, as shown in FIG. 2, the second panel 200 is connected to the first panel 100 at a top edge by the connector 300. In some embodiments, the connector 300, first panel, and second panel, defines a space or gap 310 into which the cap strap(s) may be received. In some embodiments, the cap strap(s) may be nest and fit into the space. When the attachment 10 is fitted or snapped over the strap(s), the first and second panels lie on opposite sides of the strap(s).

In some embodiments, as shown in FIG. 2, the cap attachment 10 may include one or more ridges arranged to engage or grip the straps and provide a way to hold the attachment 10 in place and prevent it from sliding back and forth and/or up and down on the strap(s). In some embodiments, the cap attachment 10 may include one or more ridges on the first and/or second panels. In some embodiments, the inner surface 110 of the first panel includes one or more ridges along an outer edge to help engage or grip the cap strap(s) and hold the cap attachment 10 relative to the cap strap. For example, the one or more ridges may help keep the attachment 10 in place on the cap. In one embodiment, the inner surface 110 has a ridge 130 along the left side edge, a ridge 140 along the right side edge, and a ridge 150 on the bottom edge. As will be appreciated, the ridges may extend around a periphery of the inner surface 110 of the first panel, although the ridges may extend along another suitable portion of the inner surface of the first panel.

In some embodiments, the left and right side ridges 130 and 140 may extend along the entire left and right edges, along the entire width of the attachment 10. As will be appreciated, the ridges 130 and 140 may be shorter in other embodiments and may extend along only a portion of the width of the inner surface 110. In some embodiments, the ridges 130 and 140 may grip the strap(s), or the cap if the first panel 100 extends beyond the length of the strap, to hold the cap attachment 110 relative to the cap strap(s). In some embodiments, the bottom ridge 150 may extend along at least along a portion of the bottom edge.

In some embodiments, as shown in FIGS. 2 and 3, the inner surface 210 of the second panel also may include a ridge 230 along a bottom edge to engage the cap strap(s). In some embodiments, the ridge 230 may extend along the entire bottom length of the second panel, although the ridge also may extend along only a portion of the bottom length of the second panel and be shorter. A complete view of the ridge 230 is shown in FIG. 1. As shown in FIGS. 2 and 3, the ridge 230 on the second panel and the ridge 150 on the first panel are opposite to each other. As shown in FIG. 3, in some embodiments, the ridge 150 on the first panel may be substantially the same length as the length of the second panel 200 ridge 230. Alternatively, the ridge 150 may be longer than the ridge 230 on the second panel.

As will be appreciated, the ridges may be of any suitable shape, size, or style to permit engagement with the strap(s). For example, the ridges may be raised or recessed. The ridges also may be square, rectangular, triangular, oval, circular, or another suitable shape. As will be further appreciated, the ridges may be the same shape and size, although the shape and size of the ridges may vary from ridge to ridge. For example, the ridges on the left and right side of the inner surface 110 of the first panel may be the same shape but may be different shapes than the ridges 150, 230 on the bottom of the inner panels 110, 210.

As will be appreciated, the cap attachment may include other mechanisms to keep the cap attachment in place on the straps. For example, the first and second panels, and/or the connector 300 may include loop and hook fasteners to attach hold the cap attachment to the strap(s).

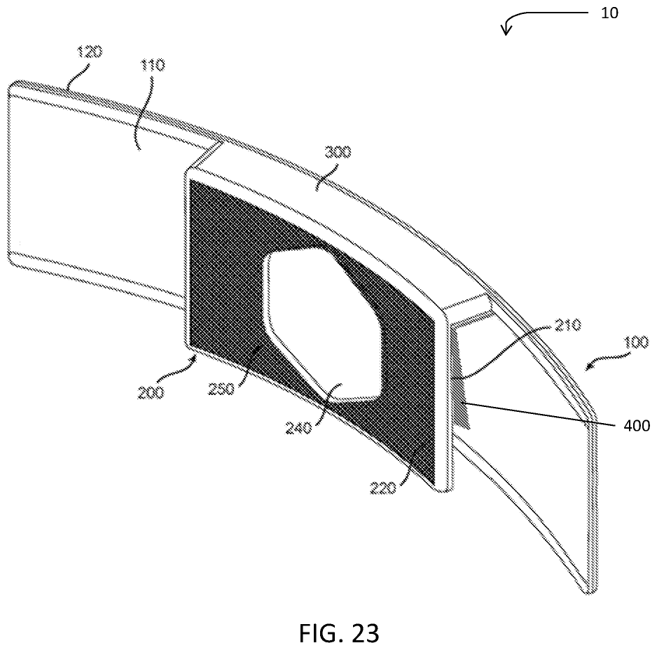

In another embodiment, as shown in FIGS. 23-27 the cap attachment may include a clip 400 arranged to hold the cap attachment on the strap(s) of the cap. In some embodiments, the clip 400 may be located in the gap 310 in between the first and second panels 100, 200. In such embodiments, only the second panel may be close to and/or contact the user head when the cap attachment is attached to strap(s) of the cap.

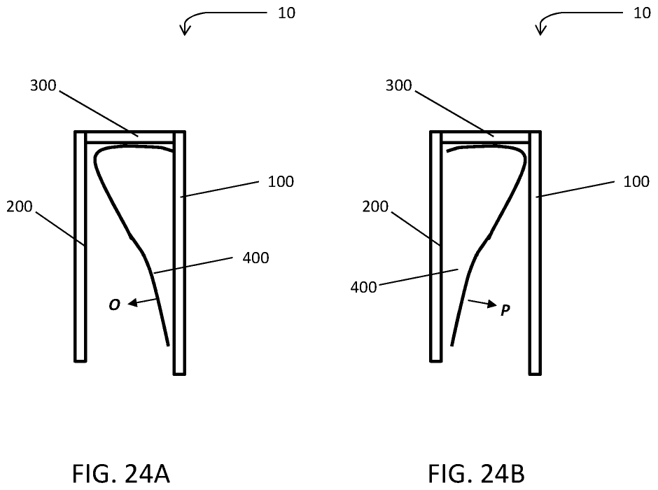

In some embodiments, as shown in FIG. 24A, the clip may be attached to the first panel 100. In such embodiments, the clip may be biased toward the first panel 100 to hold the strap(s) between the clip and the first panel 100. For example, the clip may hold the strap(s) against the inner surface of the first panel 100. In some embodiments, to attach the cap attachment to the strap(s), the user may move the clip 400 in a direction away from the first panel 100 (see the arrow labeled 0 in FIG. 24A). The user may then insert the strap(s) in between the first panel and the clip 400, and then release the clip. Once released, the clip may move in a direction toward the first panel. The clip may be biased by the shape and material of the clip. For example, the clip may be made of thin piece of metal.

In other embodiments, as shown in FIG. 24B, the clip may be attachable to the second panel 200. In such embodiments, the clip may be biased toward the second panel 200 to hold the strap(s) between the clip and the second panel. For example, the clip may hold the strap(s) against the inner surface of the second panel. In some embodiments, to attach the cap attachment to the strap(s), the user may move the clip 400 in a direction away from the second panel (see the arrow labeled P in FIG. 24B). After the user has inserted the strap(s) in between the second panel and clip 400, the user may release the clip. Once released, the clip may move in a direction toward the second panel.

In some embodiments, in addition to, or instead of, be attached to the first and/or second panels, the clip 400 may be at least partially to the connector. In such embodiments, the clip may be biased towards the first and/or second panels.

In some embodiments, the clip may be centered along a length of the first panel. The clip also may be centered along a length of the second panel. In some embodiments, the clip extends along at least a portion of the length of the first panel. In some embodiments, the clip and the second panel may be the same length. In some embodiments, the cap attachment includes on a single clip arranged to hold the strap(s) to the first and/or second panels.

A cap attachment including one of the clips disclosed herein may be used to secure the cap attachment to the fabric strap of a fitted cap. Some caps, such as fitted caps, may have a flexible strap extending across a rear opening of the cap, and the clip may help hold the cap attachment securely to the strap, while second panel protects the user from being contacted by the clip when the cap attachment is attached to a cap that the user is wearing.

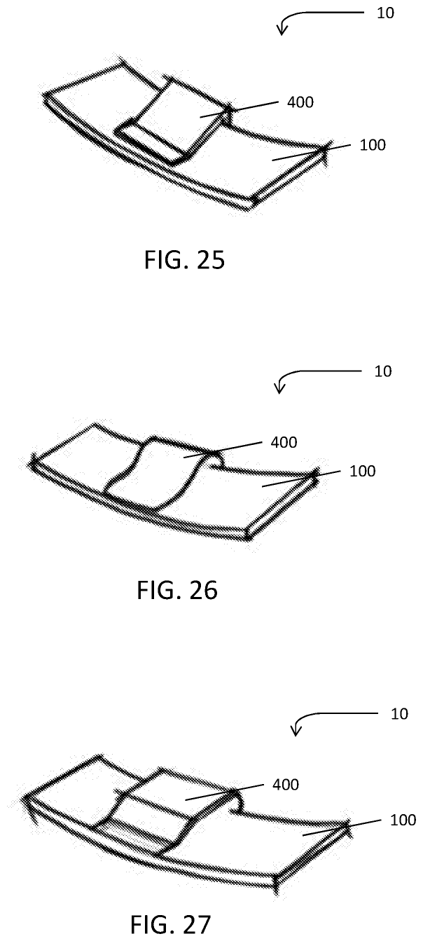

As shown in FIGS. 25-27, the clip may have any suitable arrangement. For example, the clip may have one or more portions that are curved. The clip also may include one or more planar portions that are attached to one another.

In some embodiments, the clip may extend along an entire width of the first panel. The clip also may extend along only a portion of the width of the clip. In some embodiments, the clip may extend along an entire length of the second panel. In other embodiments, the clip may extend along only a portion of the length of the second panel.

As will be appreciated, although the cap attachment is shown as having a clip positioned inside the connector and second panel, in other embodiments, the cap attachment need not include a second panel (or connector). In such embodiments, the cap attachment may include only the first panel 100 and the clip 300.

In some embodiments, the cap attachment may include a first panel and a clip section comprising a second panel and a connector connecting the two panels. The first panel may include an inner surface that is closer to the cap or user's head and an outer surface that bears advertising indicia. The second panel may have an outer surface that is in contact with the hair/skin of the person using the cap and an inner surface that is angled to press against the back surface of the first panel creating a universal clip. For example, the second panel may be spring loaded towards the first panel The inner surfaces of the two panels may face each other. The connector may connect the two panels and create a clip through which the cap straps or band passes. The attachment may snap on to the band or straps.

In another embodiment, the cap attachment may include a first panel and a clip section comprising a second panel and a connector connecting the two panels. The first panel may have an inner surface that is closer to the cap or user's head and an outer surface that bears advertising indicia. The second panel may have an outer surface that is in contact with the hair/skin of the person using the cap and an inner surface in contact with the one or two cap straps. The inner surfaces of the two panels may face each other and are joined at their bottoms by a clasp, securing the cap attachment to the strap of the cap. The connector may connect the tops of the first and second panels and may create a gap through which the cap straps or band passes. The attachment may snap on to the band or straps.

In yet another embodiment, the cap attachment may include a first panel and a clip section comprising a second panel and a connector connecting the two panels. The first panel may have an inner surface that is closer to the cap or user's head and an outer surface that bears advertising indicia. The second panel may have an outer surface that may be in contact with the hair/skin of the person using the cap and an inner surface that is angled to press against the back surface of the first panel creating a universal clip. The inner surfaces of the two panels may face each other and be joined at their bottoms by a clasp, securing the cap attachment to the strap. The connector may connect the first and second panels and create a clip through which the cap straps or band passes. The attachment may be arranged to snap on to the band or straps.

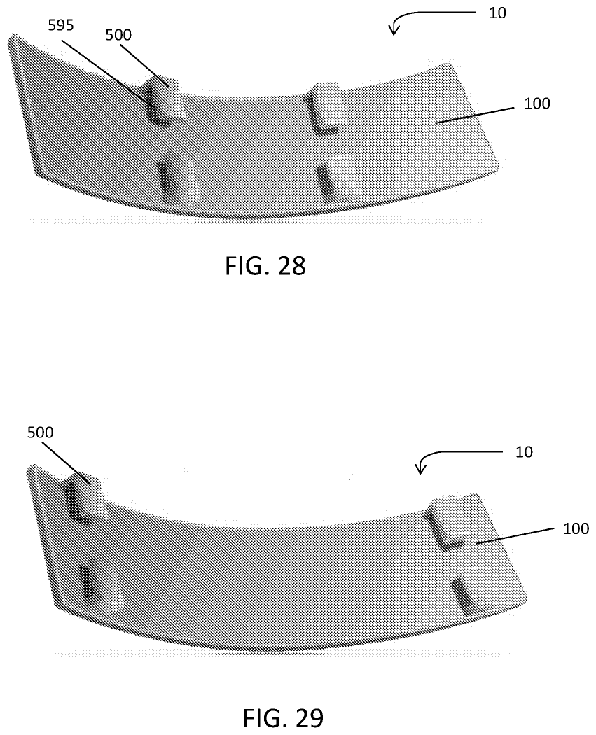

FIGS. 28-30 show other arrangements for attaching the cap attachment to the strap(s) of the cap. As shown in these views, the cap attachment may include one or more tabs 500 for holding the cap attachment onto the strap(s) of the cap. As shown in these views, a channel 595 may be formed between the tab and the first panel 100. In some embodiments, the strap(s) may be received in (e.g., slid into) the channel of each of the tab.

As shown in FIGS. 28 and 29, the cap attachment may have tabs located at the top and bottom of the first panel. In some embodiments, as shown in FIG. 28, the tabs may be located in a central region of the cap attachment. The tabs also may be positioned near or at the right and left sides of the first panel. The tabs may be located in another suitable portion of the first panel.

Although the cap attachment is shown as having the same number of tabs on the top and bottom of the first panel, the cap attachment may have different numbers of tabs on the top and the bottom. For example, the cap attachment may include two tabs on the top of the first panel and only one tab on the bottom of the first panel. Although the tabs in FIGS. 28 and 29 are shown as being vertically aligned on the top and bottom of the first panel, the tabs may be laterally offset from one another. For example, the top of the first panel may include two tabs located in a central region, and the bottom may include two tabs located at or near the left and right sides of the first panel.

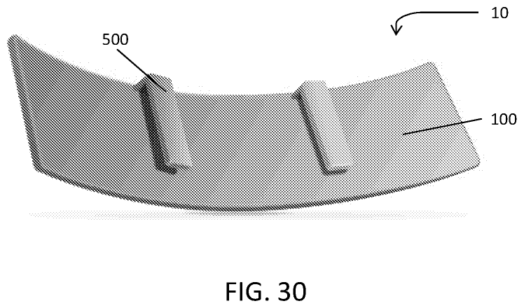

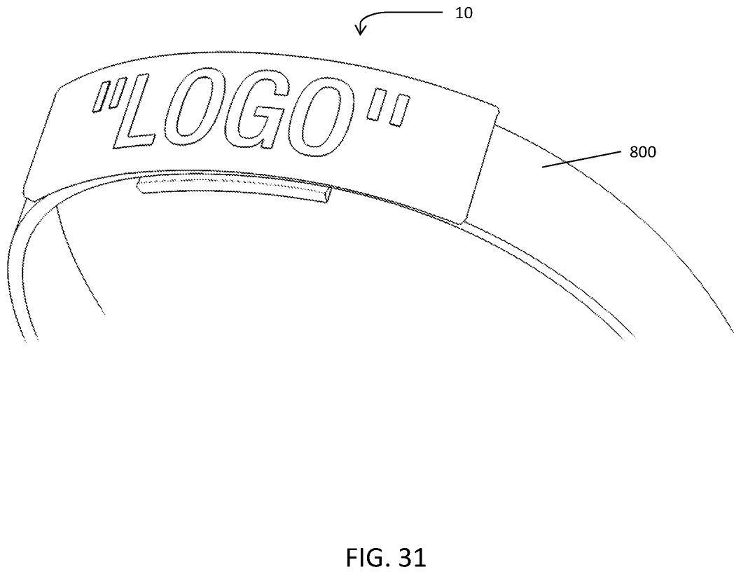

As shown in FIG. 30, the cap attachment may have tabs only on the top of the first panel. As will be appreciated, the cap attachment also may have taps located on only the bottom of the first panel (e.g., he forward-facing or front panel).

The tabs may have any suitable shape and size. For example, the tabs may be rectangular, square, oval, triangular, or other suitable shape. In some embodiments, as shown in FIGS. 28 and 29, the tabs may be the same shape and size as one another. The shape and size of the tabs also may vary from tab to tab.

Although the cap attachment of FIGS. 28-30 are shown without a second panel and connector, in some embodiments, the cap attachment may include tabs in the gap formed between the connector and the second panel. As will be appreciated, although the tabs are shown as being attached to the first panel, in other embodiments, the tabs may be attached to the second panel, or to both panels.

Turning back to FIG. 5, the cap attachment 10 is attachable to a conventional cap, such as a baseball cap 600. The cap 600 has two adjustable straps 610 and 620. The adjustment of the cap size may be achieved by means of holes and studs on the straps. The clip section of the attachment 10 may be snapped or otherwise placed over the straps. In some embodiments, the shorter length of the second panel 200 allows a wider adjustment of the cap size without affecting the position of the first panel 100 that bears the advertising indicia. For example, the longer first panel may extend beyond the straps 610 and 620 and the opening in the rear onto the cap if needed. A user may remove the cap attachment 10 from the cap by lifting the clip section to disengage the straps and/or sliding the straps out of the gap 310 (see FIG. 4) between the first and second panels.

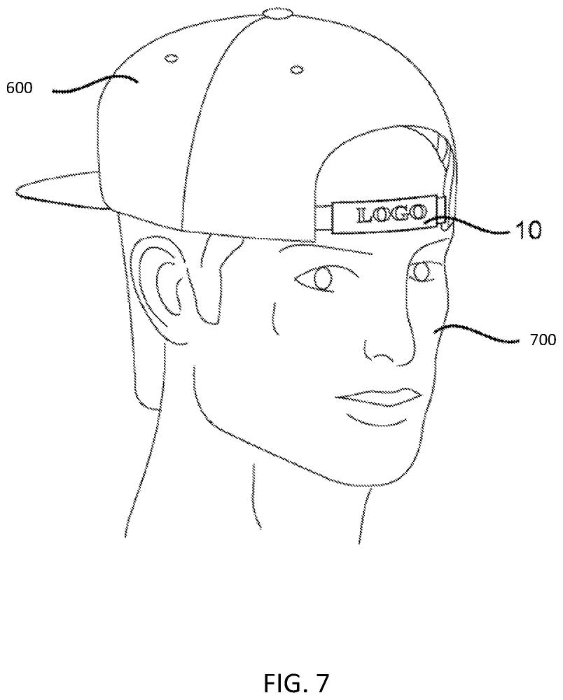

The cap attachment 10 also may be applied on the cap 600, with the user 700 wearing the cap in a conventional forward orientation. The cap may have VELCRO straps to allow size adjustment. The cap attachment 10 may be applied to any cap with an opening in the rear and a strap. The advertising indicia, such as a logo is displayed on the cap attachment positioned on the back of the user's head. When the cap is worn in this manner, the second panel is in contact with the user's hair on the head. FIG. 7 shows the cap attachment 10 applied on the cap when the user is wearing the cap backwards. In this orientation, the second panel is in contact with the user's forehead. The cushioning on the second panel increases the comfort of the user and may avoid irritation and absorb perspiration. The cushion area allows presenting a tactilely pleasant sensation to the skin or hair of the user.

Although the cap attachment has been shown and described for use with a cap, it will be appreciated that the cap attachment may be attached to other pieces of apparel. For example, in some embodiments, the cap attachment may be arranged to attach to a pet collar 800. In such embodiments, the cap attachment may include first and second panels, a connector, and a clasp. In such embodiments, the clasp may keep the first and second panels safely attached to the pet collar. For example, in some embodiments, the connector may connector a top of the first and a top of the second panel, while the clasp may connect a bottom of the first panel and a bottom of the second panel. In such embodiments, the cap attachment may snap on to the strap of the pet collar.

In some embodiments, the first panel may have an inner surface that is arranged to be closer to the neck of a pet, with an outer surface bearing indicia or design, as described above. In some embodiments, the second panel may have an outer surface arranged to contact a neck of the pet and an inner surface that cooperates with the inner surface of the first panel to hold the cap attachment to the pet collar. In some embodiments, the inner surface of the second panel may be angled to press against an inner surface of the first panel to create a clip. In such embodiments, when the cap attachment is placed onto the collar, the angled second panel may press against the collar to hold the cap attachment to the collar.

As with the other embodiments, in some embodiments, the cap attachment may include ridges along one or more edges to engage with the pet collar and keep the cap attachment in place. The cap attachment also may have a shorter second panel to allow for more adjustment of the pet collar around the pet's neck. In some embodiments, the first and second panels may be parallel and curved to conform to the shape of the animal's neck.

The cap attachment 10 may be made of any suitable material such as plastic, carbon fiber, pewter, steel, copper, silver, gold, platinum, palladium, precious metals, brass, bronze, and aluminum. In such embodiments, the cap may be formed of a rigid material. For example, the first and second panels and the connector may not deform or otherwise change shape after manufacture. In other words, the first and second panels and the connector may maintain the same shape before and after the cap attachment is attached to a cap.

In embodiments in which the cap attachment includes a clip or other member to attach the cap attachment to the cap, the clip or other member may be formed of a rigid material. For example, a rigid clip may be biased toward the first panel via a spring-loaded hinge. The clip also may at least partially formed of a resilient material such that the clip is biased towards the first panel. As will be appreciated, in such embodiments, the first and second panels and the connector may still maintain their shape and be formed of a rigid material even if the clip is formed of a material that is at least partially resilient or flexible.

The cap attachment 10 may be made by any suitable techniques such as casting, injection molding, 3D printing etc. The cushion area 250 may be made of any suitable soft and/or absorbent material such as foam, cotton, rayon, fiber etc.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A cap attachment including:
a first panel having an inner surface and an outer surface;
a second panel;
a connector arranged to connect a top of each of the first and second panels, wherein the first and second panels and the connector define a gap arranged to receive a strap of a cap; and
a clip arranged to hold at least a portion of the strap of the cap against the first panel, the clip being disposed in the gap.

2. The cap attachment of claim 2, wherein the clip is arranged to hold the at least a portion of the strap against the inner surface of the first panel.

3. The cap attachment of claim 1, wherein the clip is biased toward the first panel to hold the strap between the clip and the first panel.

4. The cap attachment of claim 1, wherein the clip is attached to the first panel.

5. The cap attachment of claim 1, wherein the clip extends along at least a portion of the length of the first panel.

6. The cap attachment of claim 1, wherein the second panel is centered along a length of the first panel.

7. The cap attachment of claim 1, wherein the clip is centered along a length of the first panel.

8. The cap attachment of claim 7, wherein the clip is centered along a length of the second panel.

9. The cap attachment of claim 1, wherein the attachment includes only one clip.

10. The cap attachment of claim 1, wherein the clip includes one or more regions that are curved.

11. The cap attachment of claim 1, wherein the clip includes one or more planar regions.

12. The cap attachment of claim 1, wherein the clip is formed of a thin piece of metal.

13. The cap attachment of claim 1, wherein the first panel includes a digital camera.

14. The cap attachment of claim 1, wherein the first panel includes a flashlight.

15. The cap attachment of claim 1, wherein the first panel includes a three-dimensional design.

16. The cap attachment of claim 1, wherein the first panel is curved.

17. The cap attachment of claim 16, wherein the second panel is curved.

18. The cap attachment of claim 17, wherein the first panel is substantially parallel to the second panel.

19. The cap attachment of claim 1, wherein the outer surface arranged to display at least one of advertising, indicia, and a decoration.

20-23. (canceled)

24. A cap attachment including:
a first panel having an inner surface and an outer surface;
a second panel;
a connector arranged to connect a top of each of the first and second panels, wherein the first and second panels and the connector defining a gap arranged to receive a strap of a cap; and
a clip arranged to hold at least a portion of the strap of the cap against an inner surface of at least one of the first and second panels, the clip being disposed in the gap.

25. The cap attachment of claim 2, wherein the clip is arranged to hold the at least a portion of the strap against an inner surface of the second panel.

26. The cap attachment of claim 1, wherein the clip is biased toward the second panel to hold the strap between the clip and the second panel.

27. The cap attachment of claim 1, wherein the clip is attached to the second panel.
